(19) United States
(12) Patent Application Publication
(10) Pub. No.: US 2004/0027765 A1
(43) Pub. Date: Feb. 12, 2004

(54) Manufacturing method for over-current protection device

(76) Inventors: Chih-Ming Yu, Kaohsiung City (TW); David Shau-Chew Wang, Taipei City (TW)

Correspondence Address: Harold V. Stotland, Seyfarth Shaw, 42nd Floor, 55 East Monroe Street, Chicago, IL, 60603-5803, US

(21) Appl. No.: 10/384,133

(22) Filed: Mar. 7, 2003

(30) Foreign Application Priority Data
Jul. 25, 2002 (TW) 091116676

(51) Int. Cl. H02H 5/04

(52) U.S. Cl. 361/103

(57) ABSTRACT

The present invention reveals a manufacturing method for over-current protection devices. A current-sensitive material strip is combined with the first and the second electrode strips, and then they are punched to produce over-current protection devices, where each over-current protection device includes a first electrode, a second electrode and a current-sensitive material layer. The combination of the current-sensitive material strip with the first electrode strip and the second electrode strip can be employed by re-flowing soldering or hot pressing followed by tin-lead solder electroplating or solder spotting, so as to facilitate automation applications, and to enhance the throughput.

### BACKGROUND OF THE INVENTION

(A) Field of the Invention

The present invention relates to a manufacturing method for over-current protection devices, and more specifically, to a manufacturing method for the over-current protection devices using current-sensitive material strips.

(B) Description of Related Art

FIG. 1(a) and FIG. 1(b) illustrate a conventional manufacturing method for over-current protection devices, where a plurality of current-sensitive elements 12 are individually adhered to the comb-like electrode strips 11, 13 to form a stacked structure 10, and then the comb-like electrode strips 11, 13 are broken to produce several over-current protection devices 15. Each over-current protection device 15 comprises a first electrode 16, a second electrode 17 and a current-sensitive material layer 18. As the over-current protection device 15 is used to protect a secondary battery, the surfaces of the first electrode 16 and the second electrode 17 are further adhered to metal foils (not shown) served as the leads for electrically connecting the cathode and anode of the secondary battery. The major disadvantage of this method is that the process is too complex to increase the production efficiency.

Nowadays, the current-sensitive material layer 18 is usually composed of an upper layer of metal foil, a lower layer of metal foil, and a center layer of conductive material having positive temperature coefficient (PTC) which includes a polymer and a conductive filler. The resistance of the PTC conductive material can be kept extremely low at normal operation due to its low sensitivity to temperature variance so that the circuit can operate normally. However, if an over-current or over-temperature effect occurs, the resistance will immediately be increased to a high resistance state (e.g. above 10⁴ ohm.) Therefore, the over-current will be reversely eliminated and the objective to protect the circuit device can be achieved.

### SUMMARY OF THE INVENTIION

The main object of the present invention is throughput improvement and cost saving of the production of the over-current protection devices. In brief, a current-sensitive material strip is combined with the first and the second electrode strips, and then they are punched by a mold to produce the required shape. A solder layer can be formed on the surfaces of the current-sensitive material strip, the first electrode or the second electrode by tin-lead solder electroplating or tin solder spotting, and thus the current-sensitive material strip can be adhered to the first electrode and the second electrode by following re-flowing soldering or thermal pressing, so as to avoid the inconvenience of individually combining each current-sensitive element to the first and the second electrode strips as in the prior art.

The manufacturing method for the over-current protection devices according to the present invention includes the following steps of (1) connecting a current-sensitive material strip to a first electrode strip and a second electrode strip to form a strip-like stacked structure, and (2) cutting the stacked structure into the over-current protection devices, where each over-current protection device comprises a first electrode, a second electrode and a current-sensitive material layer, in which the first electrode, the second electrode and the current-sensitive material layer are formed from the first electrode strip, the second electrode strip and the current-sensitive material strip, respectively.

The current-sensitive material strip may contain a PTC material. The first and the second electrode strips may be in the form of a comb-like electrode strip of Ni alloy.

Moreover, one of the first and the second electrode strips can be replaced with a plurality of sheet electrodes, or adding a step of cutting one of the first and the second electrode strips into the plurality of sheet electrodes in advance, so as to facilitate the automation of the following inspection and tape winding processes.

### BRIEF DESCRIPTION OF THE DRAWINGS

FIG. 1(a) and FIG. 1(b) illustrate a known manufacturing method of over-current protection devices;

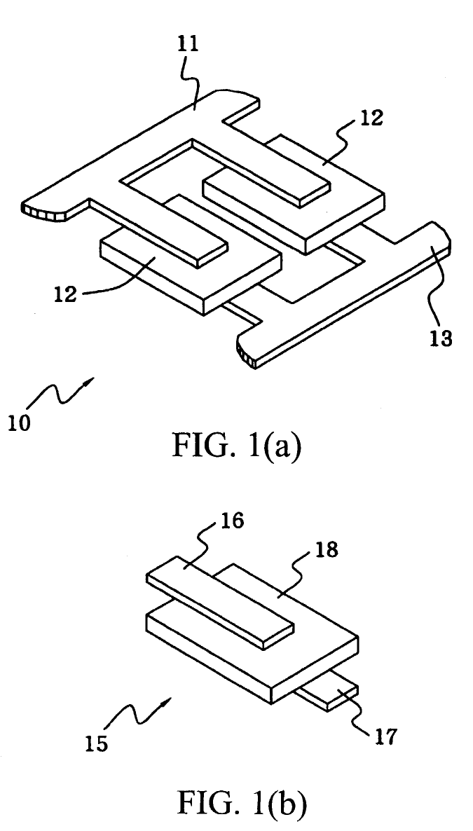

FIG. 2(a) and FIG. 2(b) illustrate the manufacturing method of over-current protection devices of the first preferred embodiment in accordance with the present invention;

FIG. 3(a) and FIG. 3(b) illustrate the manufacturing method of over-current protection devices of the second preferred embodiment in accordance with the present invention;

FIG. 4(a) and FIG. 4(b) illustrate the manufacturing method of over-current protection devices of the third preferred embodiment in accordance with the present invention; and

FIG. 5(a) to FIG. 5(c) illustrate the manufacturing method of over-current protection devices of the fourth preferred embodiment in accordance with the present invention.

### DETAILED DESCRIPTION OF THE INVENTION

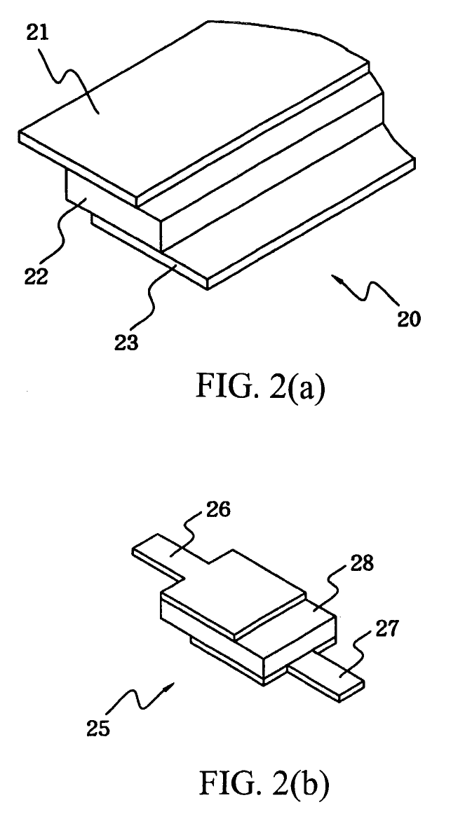

FIG. 2(a) and FIG. 2(b) illustrate the manufacturing method for over-current protection devices of the first preferred embodiment according to the present invention. FIG. 2(a) shows a strip-like stacked structure 20 comprising a sheet-like electrode strip 21, a PTC material strip 22, and another sheet-like electrode strip 23. The sheet-like electrode strips 21, 23 may be made of Ni alloy. The PTC material strip 22 comprises an upper layer of metal foil, a lower layer of metal foil, and a center layer of conductive material having positive temperature coefficient (PTC). The PTC material strip 22 can be connected to the sheet-like electrode strips 21, 23 by adding soldering-assistant agent on the junction through electroplating, solder spotting or printing like manner and sequentially performed in a re-flowing soldering furnace, or by thermal pressing using hot bar. The hot bar can heat locally to melt the interface between the sheet-like electrode strips 21, 23 and the PTC material strip 22 for connection so that the increase of the resistance of the PTC material strip 22 caused by temperature raising can be avoided. Referring to FIG. 2(b), a plurality of PTC devices 25 are generated by punching with a mold into the required shape. The sheet-like electrode strips 21, 23 are cut into a first electrode 26 and a second electrode 27, respectively. Additionally, the PTC material strip 22 is cut into the PTC material layers 28 with equal span.

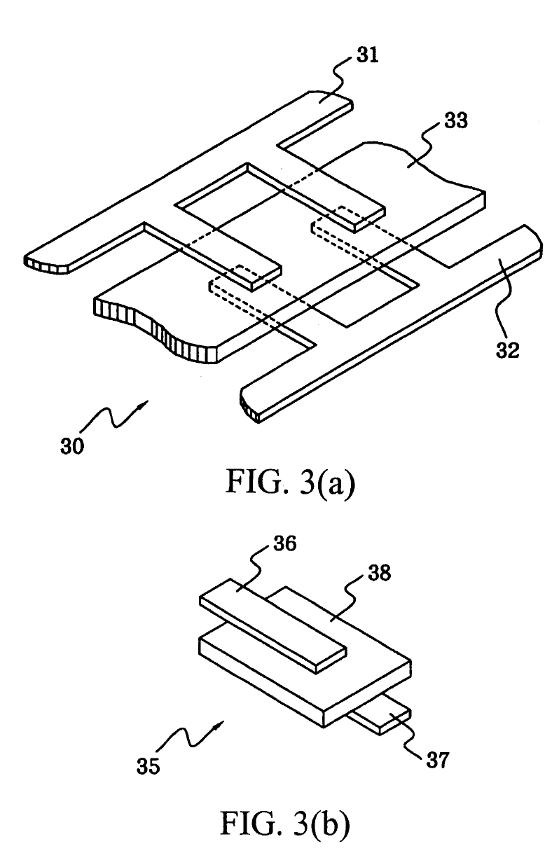

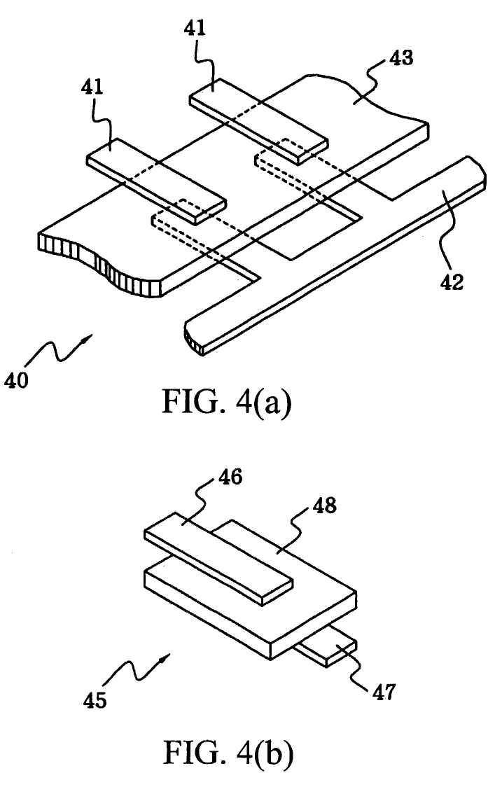

FIG. 3(a) and FIG. 3(b) illustrate the manufacturing method for the over-current protection devices of the second preferred embodiment according to the present invention. FIG. 3(a) shows a strip-like stacked structure 30 comprising a comb-like electrode strip 31, a PTC material strip 33 and another comb-like electrode strip 32. The PTC material strip 33 comprises an upper layer of metal foil, a lower layer of metal foil, and a center layer of conductive material having positive temperature coefficient (PTC). The dashed lines in FIG. 3(a) shows the sheet-like electrode strips 31, 32 adhered to the PTC material strip 33 are overlapped by an offset. Similarly, the PTC material strip 33, and the comb-like electrode strips 31, 32 can be combined by electroplating, solder spotting or hot bar. In FIG. 3(b), the stacked structure 30 is punched by a mold into the required shape to generate a plurality of PTC devices 35, in which the comb-like electrode strips 31, 32 are cut to form a first electrode 36 and a second electrode 37 respectively, and the PTC material strip 33 is cut into the PTC material layers 38 with equal span. FIG. 4(a) and FIG. 4(b) illustrate the manufacturing method for the over-current protection devices of the third preferred embodiment according to the present invention. In FIG. 4(a), a strip-like stacked structure 40 includes a plurality of sheet electrodes 41, a comb-like electrode strip 42 and a PTC material strip 43, i.e. the comb-like electrode 31 shown in FIG. 3(a) is replaced with a plurality of sheet electrodes 41 in this case. In FIG. 4(b), the stacked structure 40 is punched into a plurality of PTC devices 45 by a mold, each PTC device comprising a first electrode 46, a second electrode 47 and a PTC material layer 48. The comb-like electrode strip 42 and the PTC material strip 43 are cut into the second electrode 47 and the PTC material layer 48, respectively, and the first electrode 46 is directly made from the sheet electrode 41 without any further machining. Moreover, the sheet electrode 41 can be cut to be of a suitable size as required during manufacturing.

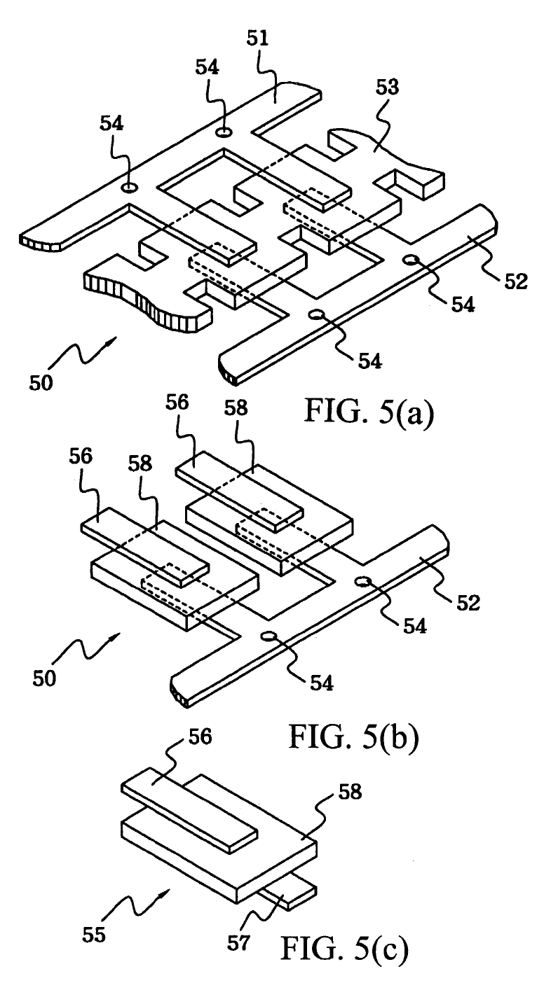

FIG. 5(a) to FIG. 5(c) illustrate the manufacturing method for the over-current protection devices of the fourth preferred embodiment according to the present invention. A strip-like stacked structure 50 shown in FIG. 5(a) comprises a comb-like electrode strip 51, a PTC material strip 53 and another comb-like electrode strip 52. The PTC material strip 53 contains concave portions at equal span, and the corresponding convex portions are used as the PTC material layers of PTC devices. In such case, the manufacturing cost of the PTC material can be reduced, but the position for punching must be more precise. The T-shape intersections of the comb-like electrode strips 51, 52 are provided with alignment holes 54, which can be driven by the manufacturing machine to improve the precision of punching. In FIG. 5(b), the comb-like electrode strip 51 and the PTC material strip 53 are punched into a plurality of first electrodes 56 and PTC material layers 58 respectively. In FIG. 5(c), the comb-like electrode strip 52 is punched to form the second electrode 57 whereby a plurality of PTC devices 55 are produced. In this case, the PTC devices are manufactured by two-stage punching. After the first-stage punching is done, the comb-like electrode strip 52 is still connected to each PTC material layer 58 so that it can facilitate the automation application for the following resistance testing or tape winding.

The above-described embodiments of the present invention are intended to be illustrative only. Numerous alternative embodiments may be devised by those skilled in the art without departing from the scope of the following claims.

What is claimed is:

1. A manufacturing method for over-current protection devices, comprising the steps of:
combining a current-sensitive material strip, a first electrode strip and a second electrode strip as a strip-like stacked structure; and
cutting the strip-like stacked structure into a plurality of over-current protection devices, each over-current protection device including a first electrode, a second electrode and a current-sensitive material layer, wherein the first electrode, the second electrode and the current-sensitive material layer are formed from the first electrode strip, the second electrode strip and the current-sensitive material strip, respectively.

2. The manufacturing method for over-current protection devices in accordance with claim 1, wherein at least one of the first electrode strip and the second electrode strip is a comb-like electrode strip.

3. The manufacturing method for over-current protection devices in accordance with claim 2, wherein the comb-like electrode strip comprises a plurality of alignment holes.

4. The manufacturing method for over-current protection devices in accordance with claim 1, wherein the combination of the current-sensitive material strip with the first electrode strip and the second electrode strip is employed by re-flowing soldering followed by tin-lead solder electroplating.

5. The manufacturing method for over-current protection devices in accordance with claim 1, wherein the combination of the current-sensitive material strip with the first electrode strip and the second electrode strip is employed by re-flowing soldering followed by tin solder spotting.

6. The manufacturing method for over-current protection devices in accordance with claim 1, wherein the combination of the current-sensitive material strip with the first electrode strip and the second electrode strip is by means of a hot bar.

7. The manufacturing method for over-current protection devices in accordance with claim 1, wherein the current-sensitive material strip, the first electrode strip and the second electrode strip are cut by punching.

8. The manufacturing method for over-current protection devices in accordance with claim 1, wherein the current-sensitive material strip has a concave-convex shape.

9. The manufacturing method for over-current protection devices in accordance with claim 1, wherein the current-sensitive material strip includes a PTC material.

10. The manufacturing method for over-current protection devices in accordance with claim 1, wherein the current-sensitive material strip comprises an upper layer of metal foil, a lower layer of metal foil, and a center layer of conductive material having positive temperature coefficient.

11. The manufacturing method for over-current protection devices in accordance with claim 1, wherein the first electrode and the second electrode are made of Ni alloy.

12. A manufacturing method for over-current protection devices, comprising the steps of:
combining a current-sensitive material strip, a comb-like electrode strip and a plurality of sheet electrodes as a strip-like stacked structure; and
cutting the strip-like stacked structure into a plurality of over-current protection devices, each over-current protection device including a first electrode, a second electrode and a current-sensitive material layer, wherein the current-sensitive material layer and the second electrode are formed by the current-sensitive material strip and the comb-like electrode strip, respectively, and the first electrode is formed by the sheet electrode.

13. The manufacturing method for over-current protection devices in accordance with claim 12, wherein the current-sensitive material strip and the comb-like electrode strip is cut by punching.

14. The manufacturing method for over-current protection devices in accordance with claim 12, wherein the plurality of sheet electrodes are formed by cutting a electrode strip.
